(19) United States
(12) Patent Application Publication
(10) Pub. No.: US 2007/0098022 A1
(43) Pub. Date: May 3, 2007

(54) Multi-processor apparatus and control method therefor

(75) Inventor: Daitarou Furuta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/640,964

(22) Filed: Dec. 19, 2006

Related U.S. Application Data
(63) Continuation of application No. PCT/JP04/08874, filed on Jun. 24, 2004.

(51) Int. Cl. H04J 3/06

(52) U.S. Cl. 370/503

(57) ABSTRACT

A multi-processor apparatus connects a plurality of processors, a shared storage area storing a boot program therein, and a real time notifying unit that notifies real time information to a read request via a bus. A real time acquiring unit is provided in each processor, and operates just after activation according to power-on to acquire real time information from a time notification control unit to register the same in a processor table on the shared storage area. An activation control unit is provided in each processor, and, after registering an own real time information of the processor, refers to real time information of another processor registered in the processor table, acquires a priority processing right to read the boot program and cause the processor to perform boot processing, when the own real time is the earliest, and deletes the own real time information when the boot processing has been completed.

### TECHNICAL FIELD

The present invention relates to a multi-processor apparatus where a plurality of processors acquire a boot program from a shared storage area bus-connected at a power-on time of a system to be activated simultaneously and a control method therefor, and particularly to a multi-processor apparatus which determines priority of activation processings performed by acquiring a boot program from a shared storage area utilizing a time stamp and a control method therefor.

### BACKGROUND ART

Conventionally, in a multi-processor apparatus where a plurality of processors and a shared storage area are connected to a bus, when a system is powered on according to an instruction from an external administration server, respective processors acquire a boot program stored in the shared storage area to be activated.

Thereby, simultaneous writings from the plurality of processors to the shared storage area occur according to power-on of the system, so that unstable access occurs. It is therefore necessary to activate any one of the processors as an initiator, where conflict is conventionally avoided using a semaphore control or the like and the plurality of processors are sequentially activated.
Patent Literature 1: JP-A-04-284550
Patent Literature 2: JP-A-02-156366

In recent years, now, by establishing a server apparatus using a multi-processor apparatus where a plurality of processors and a shared storage area are connected to a bus, installing these server apparatuses at a plurality of places physically distanced from one another, and providing a place-to-place shared storage area between the servers at the different places, a system which allows transmission/reception of required resources mutually is established.

In such a system where server apparatuses are arranged at a plurality of places in a distributing manner, power-on of the system is instructed from an external instruction from an administration server or the like so that a plurality of processors in each server apparatus are activated simultaneously or at different times.

However, avoidance of access conflict to the shared storage area based upon the semaphore control or the like can be designated by only a processor in a limited range, for example, only a processors mounted on a board, so that, when activation is performed by a processor bus-connected or a processor group according to a server apparatus installed at a different place using a boot program in the shared storage area, there is such a problem that an initiator can not be determined.

### DISCLOSURE OF INVENTION

An object of the present invention is to provide a multi-processor apparatus that determines one processor in a processor group bus-connected, and further in processor groups arranged at different places in a distribution manner as an initiator to allow sequential activation of a plurality of processors according to priority and a control method therefor. Means for solving the Problem

The present invention provides a multi-processor apparatus. The multi-processor apparatus of the present invention comprises a plurality of processors connected via a bus, a shared storage area storing a boot program used in each processor, a real time notifying unit notifying real-time information according to a read request, a real-time acquiring unit that is provided in each processor and operates just after activation based upon power-on to acquire real-time information from a time notification control unit and registers the real-time information in a processor table on the shared storage area, and an activation control unit that is provided in each processor and that refers to real-time information of another processor registered in the processor table after registering own real-time information of the processor, acquires a priority processing right when the own real-time is earliest to read the boot program to cause the processor to perform boot processing, and deletes the own real-time information of the processor from the processor table when the processor terminates the boot processing.

Here, the real time notifying unit produces real-time information based upon world standard time information (global time information) receiving from outside. The real-time notifying unit produces a time stamp as the real-time information, the real-time acquiring unit registers the acquired time stamp in the processor table and registers enable as a status of the own processor, and the activation control unit acquires a time stamp and a status of another processor from processor and determines that a time stamp of the own processor is earlier than the time stamp of the another processor without performing time stamp comparison when the status of the another processor is disable while determining whether or not the own time stamp of the own processor is earlier than the time stamp of the another processor based upon time stamp comparison.

The real-time acquiring unit is a hardware circuit that continuously performs fetch operation for reading real-time information from the real-time notifying unit to the bus and write operation for writing time information on the bus in the processor table subsequent thereto.

The real-time notifying unit includes a counter that counts clocks with a cycle equal to or less than a continuous performance time of the fetch operation and the write operation performed by the real-time acquiring unit to produce a time stamp. The continuous performance time of the fetch operation and the write operation performed by the real-time acquiring unit is the shortest read access time of the bus.

The time notifying unit produces a time window with a fixed time width when current time reaches a preset activation time and the real-time acquiring unit and the activation control unit operate only in a time band of the time window to cause a specific processor to acquire a priority processing right to activate processors sequentially.

The time notifying unit includes a counter that counts clocks with a cycle equal to or less than the shortest read access time of the bus to produce a time stamp, and resets the counter at a start time of the time window to cause the counter to start counting of effective time stamps.

A multi-processor apparatus of the present invention where a plurality of processors, a shared storage area, a time notifying unit, and a activation control unit are provided in each of at least two computer apparatuses installed at different places, each computer apparatus produces a time window with a fixed time width each time when current time reaches a different activation time set by remote operation, and each computer apparatus is activated in the activation time order by actuating the real-time acquiring unit and the activation control unit of each computer in a time band of the time window to cause a specific processor to acquire a priority processing right and activate the processors sequentially.

Here, the activation control unit of the processor of the computer apparatus set with a early activation time, which has first acquired a processing priority right initializes the shared storage area of the computer apparatus set with a late activation time to remote-copy a boot program used by the own processor when the boot processing has been terminated.

The present invention provides a control method for a multi-processor apparatus. The present invention is a control method for a multi-processor apparatus that uses a boot program stored in a shared storage area connected via a bus to activate a plurality of processors sequentially, comprising

a real-time notifying step of notifying real-time information to a read request from each processor;

a real-time acquiring step of operating just after activation due to power-on to register real-time information acquired from a real-time notifying unit by each processor in a processor table on the shared storage area; and

an activation control step of referring to real-time information of another processor registered in the processor table after one processor registers own real time information thereof and acquires a priority processing right to read a boot program and cause the one processor to perform boot processing when the own real-time is earliest and delete the own real time information from the processor table when the boot processing has been terminated.

Incidentally, details of the control method for a multi-processor apparatus according to the present invention are basically the same as the case of the multi-processor apparatus.

### EFFECT OF THE INVENTION

According to the present invention, time stamps as real-time information are acquired by a plurality of processors just after activation of the plurality of processors according to power-on of a system, a processor that has acquired the earliest time stamp is determined as an initiator by setting a maximum priority processing right to the processor, a boot program is first acquired from the shared storage area by the processor determined as the initiator, and activation is performed according performance of a boot processing. Thus, the determination of the initiator can be simplified by utilizing the time stamps.

Acquisition (fetch) of time stamps from the real-time notifying unit and registration (write) of the time stamps in the processor table of the shared storage area which are performed by the processors are performed as a continuous operation, for example, as a real-time fetch and write operation of a hardware circuit, and the continuous operation is performed using a real time of the real-time fetch and write operation performed with a clock equal to less than a cycle of a counter counting time stamps (a clock equal to or less than the shortest bus clock cycle), so that a plurality of processors are prevented from acquiring the same value of time stamp and the maximum priority processing right can be set to only one processor according to time stamp comparison.

When a processor group is formed of a plurality of processors provided in each of server apparatuses installed at different places, a different time window is set to each processor group and activation processing is performed according to setting of the maximum priority processing right performed by making a time stamp effective only in a time band in the time window, so that activation processing can be performed by determining one processor first serving as an initiator when a system has been powered on regardless of any increase of the number of processors in processor groups installed at a plurality of places. By making start times of time windows different from one another, activation processing ordered to processor groups distributed at different places can be performed.

### BRIEF DESCRIPTION OF DRAWINGS

FIG. 1 is a block diagram showing a system configuration together with a function configuration of the present invention;

FIG. 2 is a block diagram showing a processor, a shared storage memory, and a real-time notifying unit taken out of FIG. 1;

FIG. 3 is an explanatory diagram of a processor table stored in a shared memory;

FIGS. 4A to 4C are time charts of setting of time windows to processor groups and effective count processing of time stamps in two servers;

FIGS. 5A to 5E are time charts of acquisition and registration processing of time stamps performed by an real time acquiring unit of a processor;

FIG. 6 is a time chart of an activation control processing according to the present invention in an example of two processors;

FIG. 7 is a time chart of the activation control processing according to the present invention subsequent to the processing in FIG. 7;

FIG. 8 is a flowchart of a real time notifying processing according to the present invention; and

FIG. 9 is a flowchart of an activation control processing according to the present invention.

### BEST MODE FOR CARRYING OUT THE INVENTION

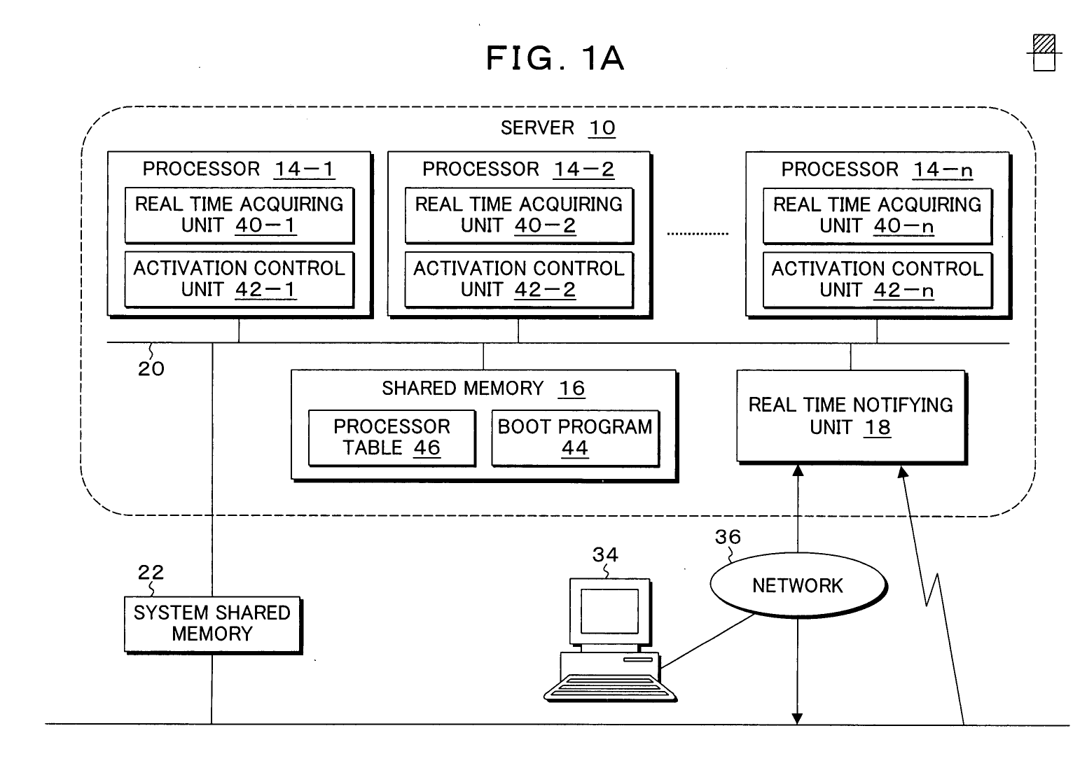

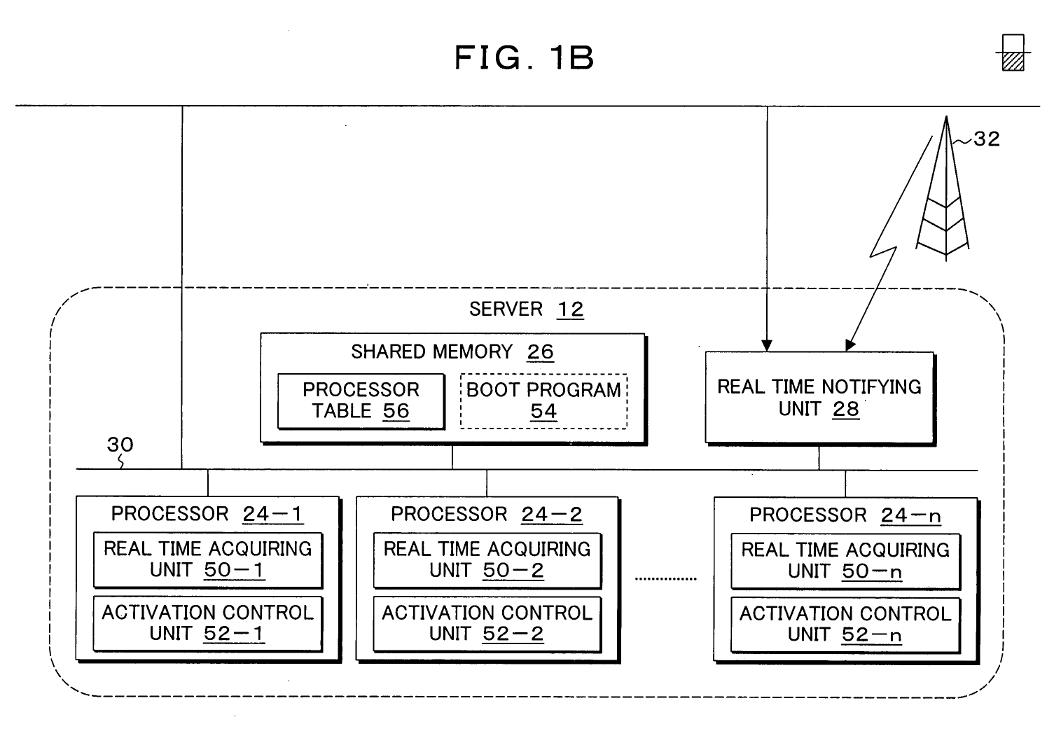

FIG. 1 is a block diagram showing a system configuration of a multi-processor apparatus according to the present invention together with a function configuration. In FIG. 1, a multi-processor apparatus of the present invention includes a server 10 and a server 12 installed in the embodiment, and the server 12 is installed at a different installation place from an installation place of the server 10. The server 10 includes n processors 14-1, 14-2, . . . 14-n.

A shared memory 16 functioning as a shared storage area is connected to the processors 14-1 to 14-n via a bus 20, and an real time notifying unit 18 is further provided. On the other hand, the server 12 includes n processors 24-1, 24-2, . . . ,24-n, and a shared memory 26 and a real time notifying unit 28 are connected to the processors 24-1, 24-2, . . . ,24-n via a bus 30.

A system shared memory 22 is connected between the bus 20 of the server 10 and the bus 30 of the server 12, so that transmission/reception between the server 10 and the server 12 can be performed via system shared memory 22. The real time notifying unit 18 of the server 10 receives global time information from a global time transmission station 32 and it notifies time stamp information as a real time to a read request from the processors 14-1 to 14-n.

A boot program 44 used for activation control of the processors 14-1 to 14-n, namely, a boot processing is stored in the shared memory 16. A processor table 46 on which the processors 14-1 to 14-n have acquired time stamps from the real time notifying unit 18 is registered is provided in the shared memory 16. Functions of real time acquiring units 40-1, 40-2, . . . 40-n and activation control units 42-1, 42-2, . . . 42-n are provided in the respective processors 14-1 to 14-n.

Just after the real time acquiring units 40-1 to 40-n receive an power-on instruction according to remote operation from the administration server 34 via a network 36 to be activated, or when a time window is produced at an arrival time of a remotely set activation time, they operate to acquire time stamps as real time information from the real time notifying unit 18 to register them on the processor table 46 in the shared memory 16.

“Enable” is simultaneously registered on the processor table 46 as statuses of the processors 14-1 to 14-n in an activation state while “disable” is registered therein in a non-activation state. After the activation control unit 42-1 to 42-n register time stamps acquired from the real time notifying unit 18 as their own real time information in the processor table 46, they are activated by referring to time stamps of the other processors registered in the processor table 46 to acquire a priority processing right when the own time stamp is earliest and reading the boot program 44 in the shared memory 16 based upon the acquisition of the priority processing right to perform a boot processing, and they delete their time stamps from the processor table 46 when terminating the boot processing and perform a processing for setting the statuses to “disable”.

Functions of the real time notifying unit 18 in such a server 10, and the real time acquiring units 40-1 to 40-n and the activation control units 42-1 to 42-n provided in the processors 14-1 to 14-n are the same as those of a real time notifying unit 28 in the server 12 and real time acquiring units 50-1 to 50n and activation control units 52-1 to 52-n provided in processors 24-1 to 24-n installed in a different place.

The time stamps as the real time information from the real time notifying units 18, 28 provided in the server 10 and the server 12 become effective only in a time band of a time window over a fixed time from activation start time set according to remote operation by the administration server 34. In the embodiment, the administration server 34 sets time frames over 1 hour from different activation times t1, t2 to the real time notifying units 18, 28 of the server 10, 12 according to remote operation.

When the different activation times t1, t2 are set to the servers 10, 12, respectively, the real time notifying units 18, 28 invalidate values of time stamps based upon reception of the global time from the global time transmission station 32 until current time reaches the activation times t1, t2 set respectively in a state that the system is operating based upon a power-on instruction to the server 10 and the server 12 according to remote operation from the administration server 34, and the boot processing is not performed according to execution of the boot program 44 based upon the acquisition of the time stamp from the real time notifying unit 18 even in a state that the system is in a power-on state, so that the servers 10, 12 are put in a activation standby state.

When arrival to the activation time t1 is determined by the real time notifying unit 18, an operation for counting time stamps based upon reception of the global time from the global time transmission station 32 becomes effective in a time period of, for example, 1 hour from the activation time t1. At this time, time stamps as the real time information are acquired effectively to read requests from the processors 14-1 to 14-n to be registered on the processor table 46, and a priority processing right is set to a processor having the earliest time in the processor table 46, so that a processor that has first acquired the priority processing right in the boot processing based upon the acquisition of the boot program 44 is activated as an initiator.

In the server 10, for example, when the processor that has first acquired the priority processing right is the processor 14-1, after the processor 14-1 is activated by reading the boot program 44 from the shared memory 16 to perform the boot processing, a storage area of the boot program in the shared memory 26 in the server 12 where the late activation time t2 has been set is initialized, and a copy of the boot program 44 executed in the processor 14-1 is then stored in the shared memory 26 in the server 12 as a boot program 54 according to remote copying.

The server 12 producing a time window at the activation time t2 after the activation time t1 of the server 10 to operate based upon storing of the boot program 54 in the server 12 according to the remote copying substantially performs activation control under control of the processor 14-1 serving as the initiator of the server 10 that has operated in first.

FIG. 2 is a block diagram showing a function configuration of the processor 14-1, the shared memory 16, and the real time notifying unit 18 provided on the server 10 side shown in FIG. 1 and taken out of FIG. 1. In FIG. 2, the processor 14-1 is composed of a CPU 60, a BIOS (basic input/output system) 64, and a bus interface 66, and a time fetch write circuit 68 is further provided as a hardware circuit functioning as a real-time acquiring unit 70 in the present invention.

A function serving as an activation control unit 72 in the present invention is provided in the BIOS 64. The real time notifying unit 18 connected via the bus 20 includes a real time receiving device 74, a time window producing device 76, and a status register 78. The real time receiving device 74 receives a signal from the global time transmission station 32 to output real time information in synchronism with a global time.

The time window producing device 76 is set with the activation time t1 according to remote operation by the administration server 34 shown in FIG. 1 and the like, it produces a time window occupying a fixed time when the global time received in the real time receiving unit 74 reaches the set activation time t1, and it produces an effective time stamp that can be acquired by an access from the real time acquiring unit 70 of the processor 14-1 over a producing time of the time window.

Information about the power-on instruction of the system from the administration server 34 shown in FIG. 1, the activation start time, and the like are reserved in the status register 78.

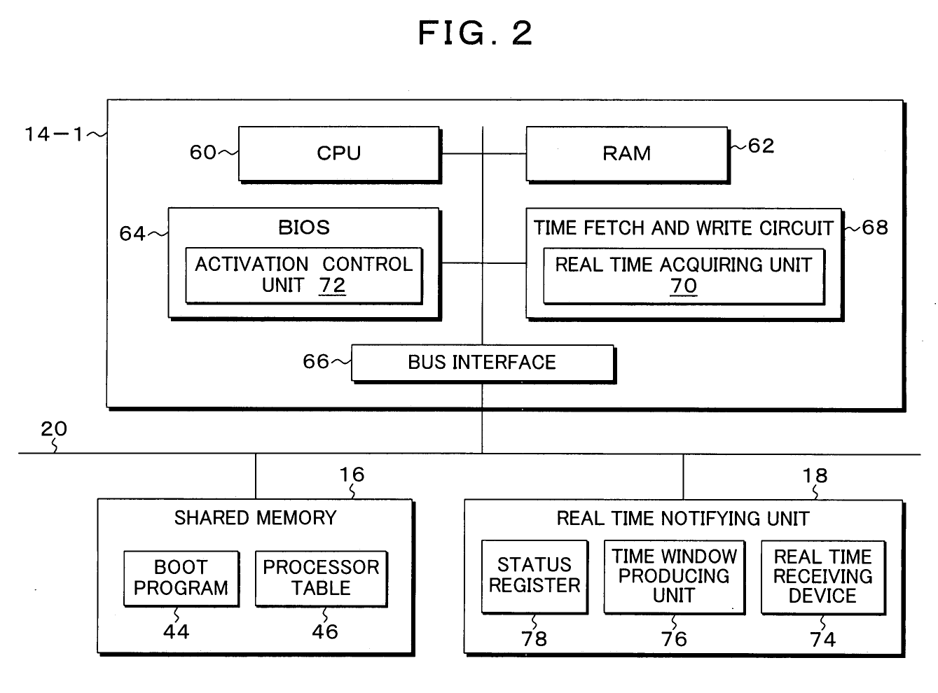

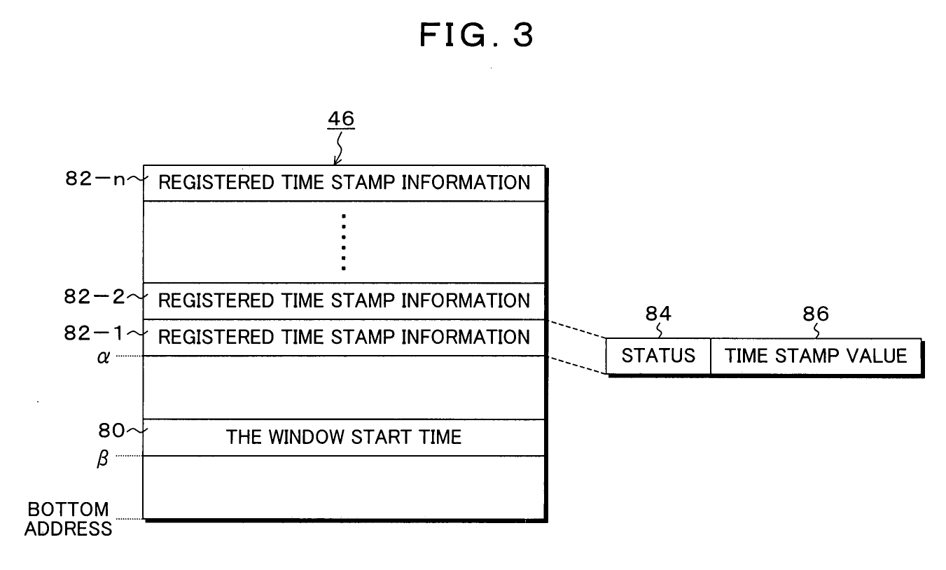

FIG. 3 is an explanatory diagram of the processor table 46 stored in the shared memory 16 shown in FIG. 2. In FIG. 3, the processor table 46 stores a time window start time 80 serving as an activation time set according to remote operation from the administration server 34 in an address β utilizing a bottom address in the shared memory 16 as a starting point.

Subsequently, registered time stamp information 82-1, 82-2, . . . ,82-n are stored for the respective processors 14-1 to 14-n from an address α. The registered time stamp information 82-1, 82-2, . . . ,82-n are each composed of a status 84, and a time stamp value 86 that have been taken out to the right side regarding the registered stamp information 82-1 for showing.

In an initial state, a status 84 is “disable”, and an initial value [9999:99:99] is stored as a time stamp value 86. A value of a time stamp acquired according to production of a time window occupying a fixed time from a time window start time 80 in the server 12 is stored in the time stamp 86 and the status 84 is simultaneously rewritten to “enable”.

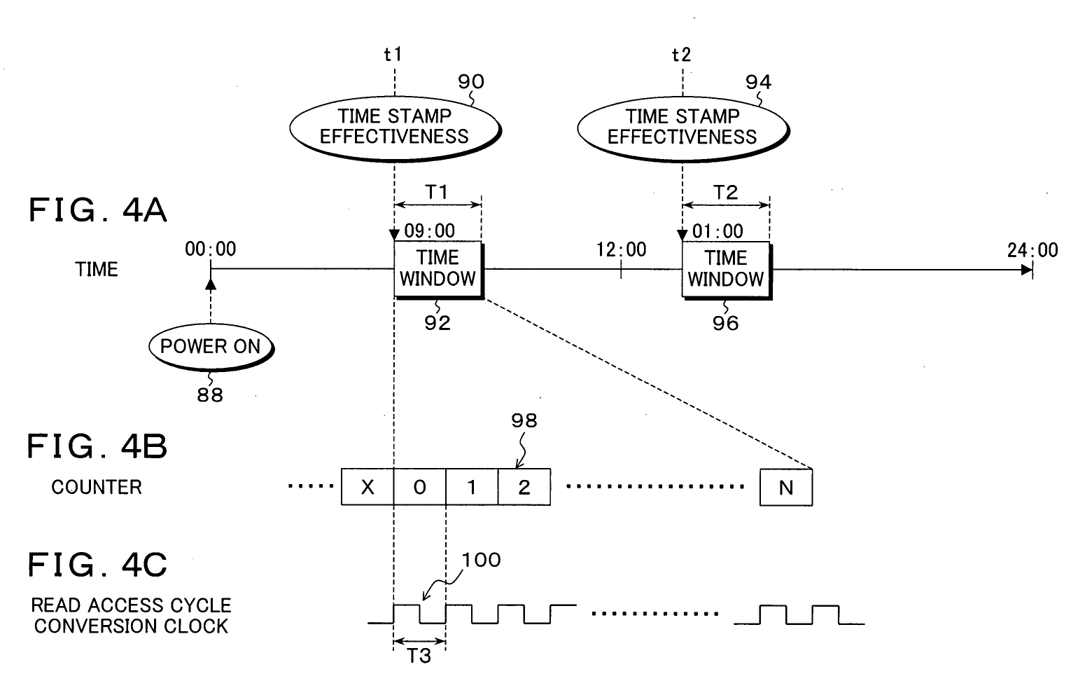

FIGS. 4A to 4C are time charts of setting of time windows to two processor groups performed by the two servers shown in FIG. 1 and an effective count processing of time stamp. FIG. 4A shows a time axis of 24 hours/day, where an instruction of power-on 88 is issued from the administration server 34 to a time [00:00], a time window start time t1 is set to the server 10, and a time window start time t3 is set to the server 12.

Here, for example, the time window start time t1 of the server 10 is t1=09:00, while the time window start time t2 of the server 12 is t2=01:01:00. The server 10, 12 put in a performance state according to the power-on 88 checks whether or not a current time based upon the global time has reached the time window start time t1 or t2, starts a processing for determining time stamp effectiveness 90 when the current time has reached the time window start time t1, and produces a time window 92 occupying a fixed time Ti. In the time window 92, a time stamp value x of the counter counting time stamps shown in FIG. 4B is reset to 0, and an effective time stamp 98 is produced by the counter using clocks shown in FIG. 4C.

A clock cycle T3 shown in FIG. 4C and counting effective time stamps 98 is one time fetch and write performance time for performing writing in the processor table 46 of the shared memory 16 after the time fetch and write circuit 68 of, for example, the processor 14-1 shown FIG. 2 has issued a read request and has acquired the same, where time stamps are counted as a so-called read access cycle converting clock.

The clock cycle T3 serving as the read access cycle converting clock is specifically set to a clock cycle equal to or less than the shortest read access time of the bus 20. By counting a value of time stamps value based upon such a clock cycle T3, even if read access of the time stamp to the real-time notifying unit 18 is simultaneously performed by a plurality of processors, only one processor necessarily acquires a time stamp effectively to register the same to the processor table 46, thereby preventing the same time stamp from being registered regarding different processors.

When the fixed time Ti based upon the time window 92 elapses, the counter is cleared so that a so-called free run state occurs. Therefore, the processors 14-1 to 14-n in the server 10 can perform activation processing based upon a priority processing right based upon acquisition of a time stamp in the time band T1 of the time window 92.

On the other hand, in the processors 24-1 to 24-n in the server 14, a time stamp value obtained by the counter becomes effective only in a time band of the time window 96 of the fixed time T2 generated when the current time has reached the time window start time t2=01:00 as shown in FIG. 4B like the case of the time window 92 of the server 10, so that activation control is sequentially performed by setting a priority processing right to a processor having the earliest time stamp value as an initiator based upon acquisition of time stamp values performed by the processors 24-1 to 24-n and reading the boot program 54 stored in the shared memory 26 to execute the program according to remote copy by the initiator in the server 10.

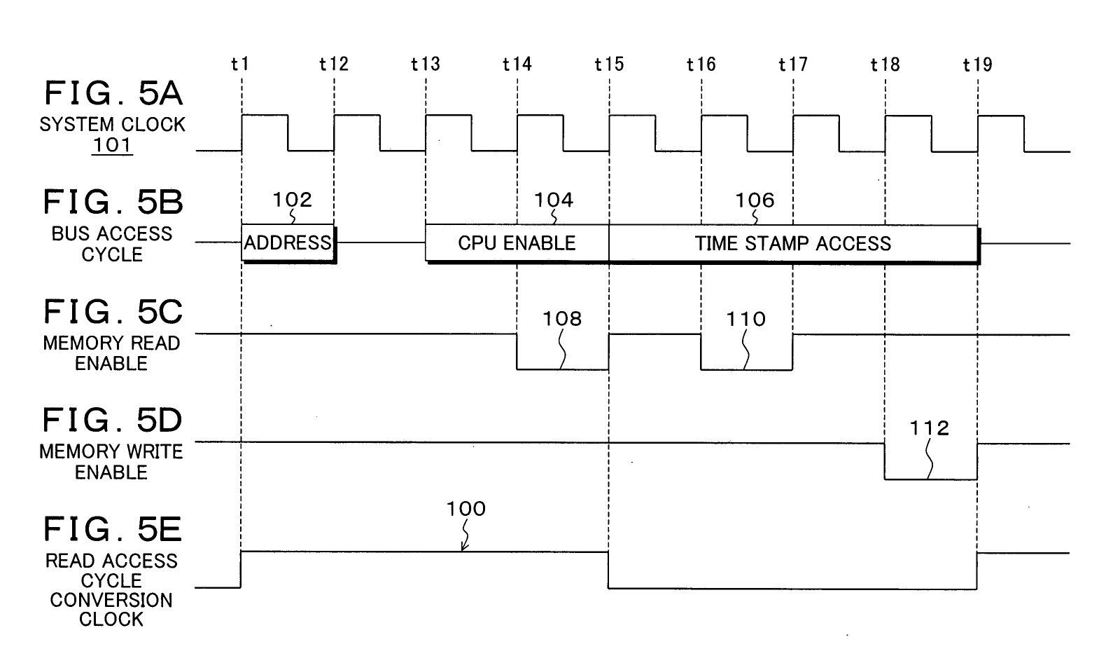

FIGS. 5A to 5E are time charts of acquisition and registration processing of a time stamp that is first performed in the time window 92 of the server 10 shown in FIGS. 4A to 4C, for example, performed in the real-time acquiring unit 40-1 of the processor 14-1. FIG. 5A shows a system clock 101 which is a clock having a cycle of ⅛ of a read access cycle converting clock 100 which is a clock of a counter counting time stamps shown in FIG. 5E.

FIG. 5B shows an access cycle of the bus 20, where the time fetch write circuit 68 shown in FIG. 2 outputs an address 102 to the bus 20 at the time t1, subsequently reads a CPU enable 104 indicating a status of the CPU 60 to the bus at a timing from a time t13 to a time t15, and further performs a time stamp access 106 occupying a range of the time t15 to a time t19 for reading a time stamp from the real-time acquiring unit 70.

A memory read enable shown in FIG. 5C is outputted in correspondence to the bus access cycle shown in FIG. 5B. In the memory read enable, reading of the CPU enable 104 based upon read enable 108 occupying a range of a times t14 to t15 and reading of the time stamp access 106 based upon read enable 110 occupying a range of a times t16 to t17 from the real time notifying unit 18 are continuously performed two times.

Further, FIG. 5D shows memory write enable to the processor table 46 of the shared memory 16, where write enable 112 is outputted at a timing occupying a range of a times t18 to t19, and respective values of the CPU enable 104 and the time stamp access 106 being outputted on the bus 20 are written in the status 84 and the time stamp value 86 in the registered time stamp information 82-1 in the processor table 46 shown in FIG. 3.

As the time chart shown in FIGS. 5(A) to 5(D), the fetch and write operations to time stamps are continuously performed by the hardware in the time fetch and write circuit 68 operating as the real time acquiring unit 70 of the processor 14-1 shown in FIG. 2.

The performance time of the fetch and write operation of the time stamp, namely, the read access cycle converting clock shown in FIG. 5E, is used as the count clock of the time stamp value shown in FIG. 4B in the time window 92, as shown in FIGS. 4A to 4C, so that, even if simultaneously acquisition of time stamps is performed by a plurality of processors 14-1 to 14-n, a value of a time stamp at this time can be acquired only to one specific processor at one access to the time stamp to be registered in the processor table 46.

Therefore, in a state that a plurality of processors put in the enable state have acquired the time stamps and have registered them in the processor table 46, since the value of the time stamp of one processor of the processors necessarily shows the earliest value, a priority right of a processing is set to the processor having the earliest time stamp value, so that activation of processors can be performed by performance of the boot processing according to loading of the boot program.

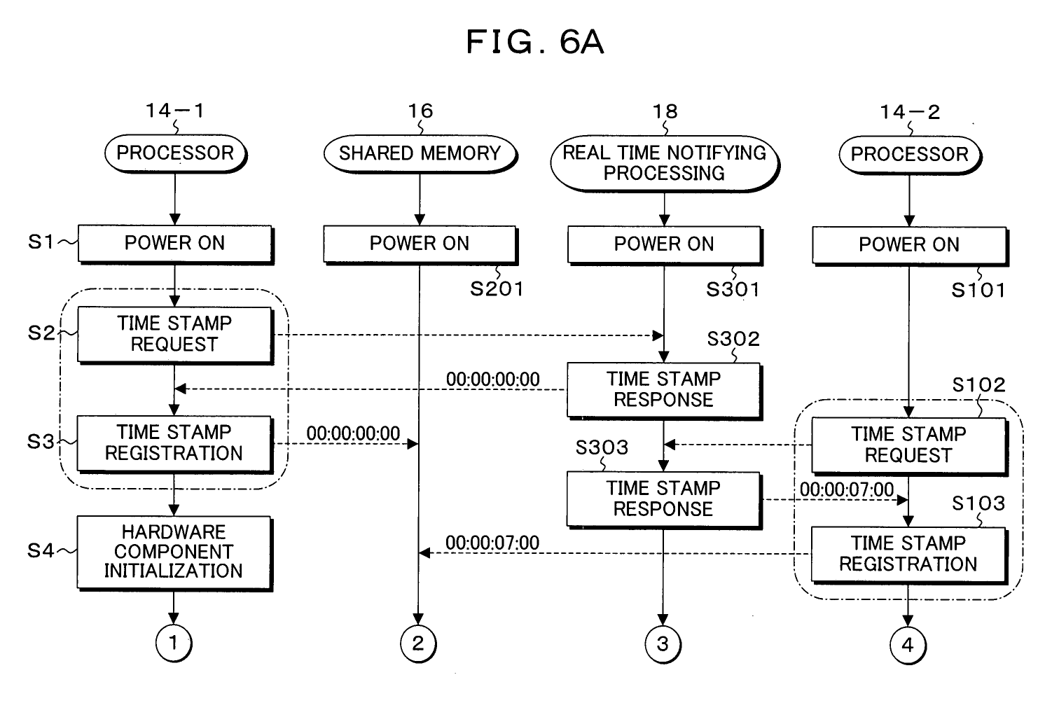

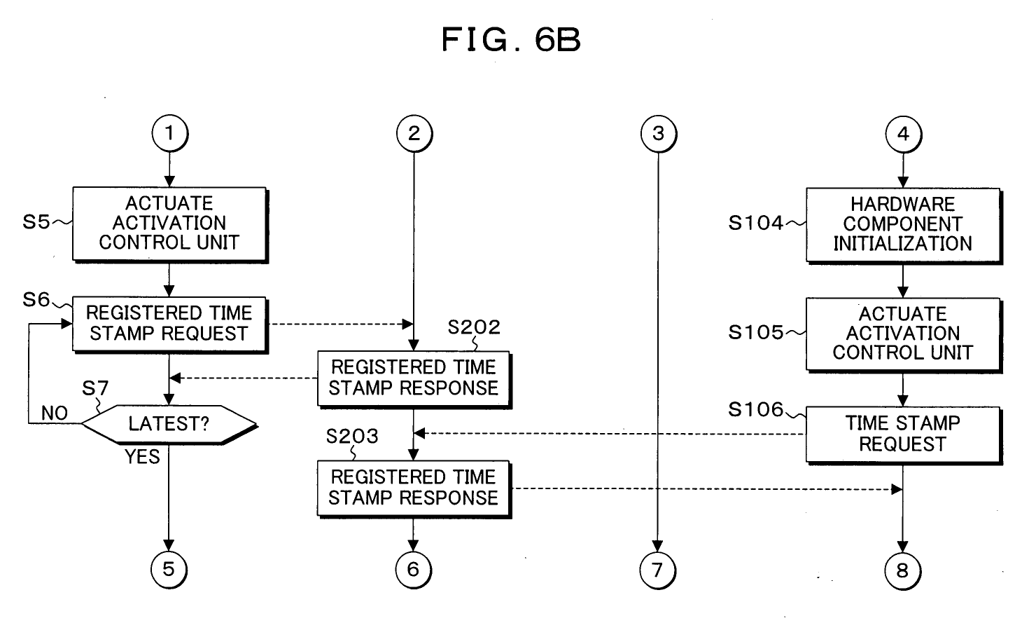

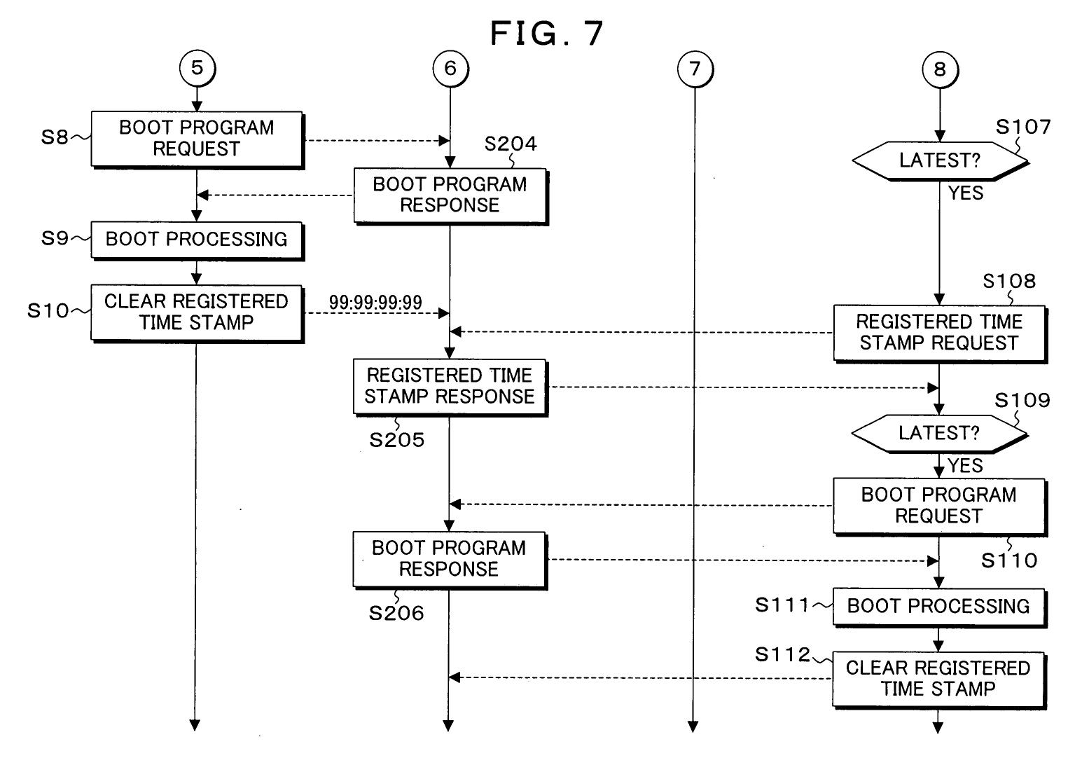

FIG. 6 and FIG. 7 are time charts showing activation control processing of the two processors 14-1, 14-2 as an example together with processings of the shared memory 16 and the real time notifying unit 18. In FIG. 6 and FIG. 7, the processors 14-1, 14-2, the shared memory 16, and the real time notifying unit 18 receive power on instructions according to remote control from the administration server 34 to be put in an initialized state where their components have been initialized via, for example, self-tests performed after they are respectively powered on according to power-on, as shown in step Si, step S101, step S201, and step S301, respectively.

In this state, when the sever 12 reaches the time window start time, the notifying function of a time stamp is made effective, and on reception of such a fact, the processors 14-1, 14-2 require time stamps from the real time notifying unit 18 at respective steps S2, S102 like just after activation thereof according to power-on.

Here, assuming that a request of the time stamp from the processor 14-1 at step S2 is first issued, the real time notifying unit 18 sends a response of a value [00:00:00:00] of a time stamp being produced at this time to the processor 14-1 at step S302, and upon reception of the value, the processor 14-1- registers a value of the time stamp acquired at its own allocation position in the processor table 46 in the shared memory 16 and makes the status “enable” at step S3.

The processings at the steps S2, S3 are performed as a continuous processing. Subsequently, the processor 14-1 performs initialization of the hardware component at step S4, it activates the activation control unit 42-1 at step S5.

On the other hand, the processor 14-2 issues a time stamp request with a time delay from the processor 14-1 at step S102, receives a response of a value [00:00:07:00] of a time stamp from the real time notifying unit 18 at step S303, registers the value of the time stamp and the status at the corresponding position in the processor table 46 at step S103, terminates hardware component initialization at step S104, and then starts actuation of the activation control unit 42-2 a step S105.

In such a situation where the processor 14-1 first acquires the time stamp and the processor 14-2 then the acquires time stamp in this manner, when the processor 14-1 requires a registered time stamp to the shared memory 16 at step S6 and receives the registered time stamp at step S202, the processor 14-1 compares its own registered time stamp and a time stamp of another processor 14-2 with each other at step S7, whereby it is determined in the comparison that the own time stamp is the latest, so that the processor 14-1 acquires a priority processing right.

Therefore, the processor 14-1 requires loading of the boot program to the shared memory 16 at step S8, to which read response of the boot program is issued at step S204, and a boot processing of the processor 14-1 is first performed at step S9.

When the boot processing at step S9 is terminated, clear of the registered time stamp and rewriting of the status to disable are instructed to the shared memory 16 at step S10. On the other hand, the processor 14-2 requires a time stamp to the shred memory 16 at step S106, and when the processor 14-2 receives a response of a registered time stamp at step S203, it can not acquires a priority processing right because the time stamp of the processor 14-1 is earlier than the own time stamp of the processor 14-2 in time stamp comparison at step S107, so that the processor 14-2 repeats the request for the registered time stamp and comparison determination at a fixed cycle.

After the processor 104 clears its own time stamp, it receives a response of a registered time stamp of step S205 to the time stamp request at step S108, and it acquires a priority processing right because the own time stamp of the processor 14-2 is the latest in time stamp comparison at step S108, so that the processor 14-2 issues a boot program request to the shared memory 16 at step S110 and it receives read response of the boot program at step S206 to perform boot processing at step S111.

The processor 14-2 requires the shared memory 16 to perform clearing of the own registered time stamp of the processor 14-2 and rewriting of the status to disable according to termination of the boot processing at step S12. Thus, the processors 14-1 and 14-2 perform boot processings in the order of the time stamps respectively acquired from the real-time notifying unit 18 to be activated sequentially.

In the boot processing of the processor 14-1 at step S9, a first physical sector in the shared memory 16 is read as a master boot sector, and an image of the master boot sector is loaded in the RAM 62. Thereafter, the BIOS 64 performs processing of the image of the master boot sector in the RAM 62. A table showing an address position of the boot program 44 and an executable code in the shared memory 16 are included in the master boot sector record developed in the RAM 62, and the executable code examines the shared memory 16 to identify a storage position of the boot program 44.

Thereby, the master boot record finds a start position of the boot program 44 to load an image of the first sector, namely, a boot sector, in the RAM 62. Thereafter, the master boot record in the RAM 62 performs the boot sector image at a leading position of the boot program 44 to develop an OS executed in the processor 14-1 in the RAM 62 and it develops an application program to terminate the activation processing.

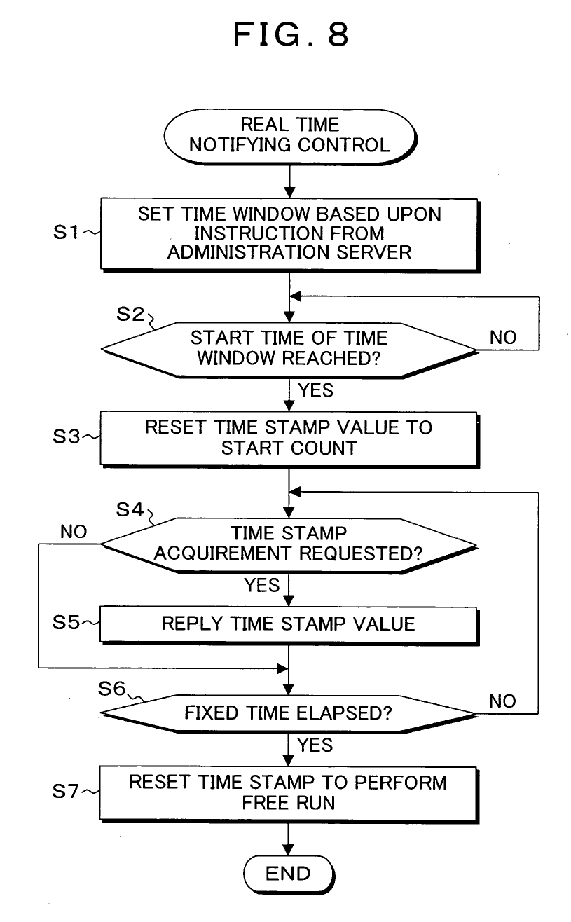

FIG. 8 is a flowchart showing processing operation performed by the real time notifying unit provided in the processor of the present invention. In FIG. 8, the real time notifying unit sets a time window start time based upon an instruction from the administration sever 34 at step S1, and it checks whether or not current time reaches the time window start time based upon reception of the global time at step S2.

When the real time notifying unit determines that the current time reaches the time window start time at step S2, it reset the counter that counts time stamps to start counting at step S3, so that values of time stamps are produced effectively over a production time of the time window. Subsequently, when a time stamp acquisition request is issued at step S4, the real time notifying unit send response of a time stamp value at step S5.

When a fixed time preset from the time window start time as step S6 elapses, the control proceeds to step S7, where the real time notifying unit resets the counter for the time stamp to a free run state and makes the time stamp ineffective.

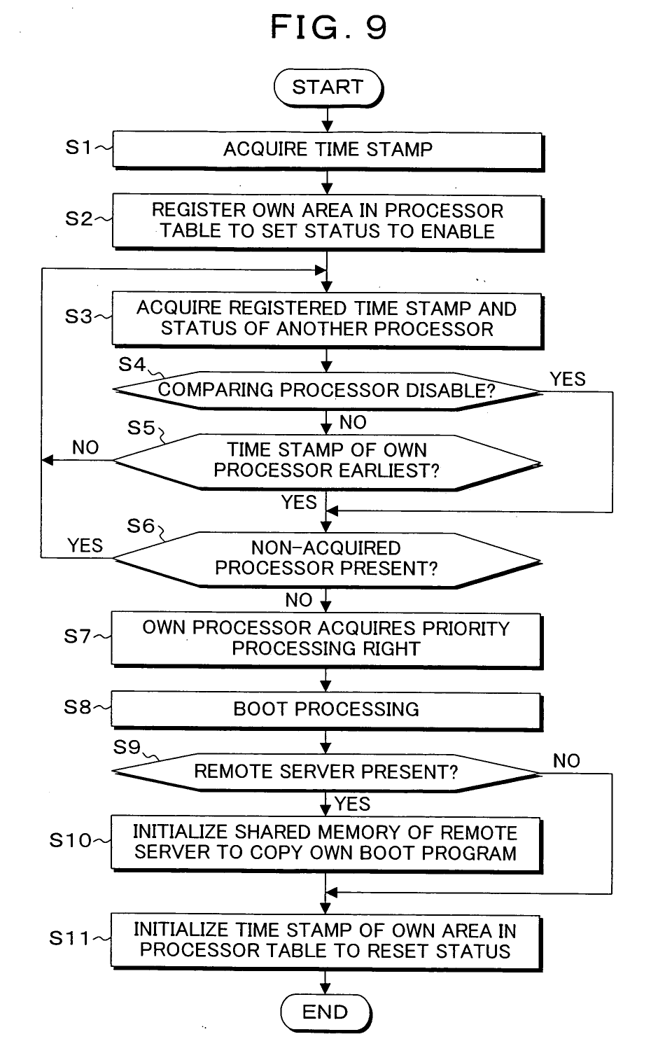

FIG. 9 is a flowchart of the activation control processing performed by the activation control unit provided in the processor of the present invention. In FIG. 9, just after actuation of the activation control unit according to arrival of the time window start time, the activation control unit accesses the real time notifying unit to acquire a time stamp at this time at step Si, and it acquires a time stamp to its area of the processor table 46 in the shared memory 16 to set the status to enable at step S2.

Subsequently, the activation control unit refers to the processor table 46 in the shared memory 16 to acquire registered time stamps and statuses of other processors at step S3. The activation control unit then checks whether or not the statuses of the other processors acquired for comparison are disable at step S4.

When the status is not disable, namely, enable, since the time stamp has been registered effectively, the control proceeds to step S5, where the activation control unit compares the time stamps of the own processor and the other processors to check whether or not the time stamp of the own processor is the earliest. When the time stamp of the own processor is the earliest, the control proceeds to step S6, and when there is a non-acquired processor, the control returns back to step S3 again, where the activation control unit acquires a time stamp of another processor to make comparison similarly.

That the status of the processor to be compared at step S4 is disable means that registration of the time stamp is not made effectively, time stamp comparison at step S5 is skipped.

When any non-acquired processor has not been found at step S6, the control proceeds to step S7, where, assuming that the own processor has acquired a priority processing right, the activation control unit reads the boot program from the shared memory to perform a boot processing. Subsequently, the activation control unit checks whether or not a remote server 12 is present as viewed from the server 10 shown in FIG. 1 at step S9.

When the remote server is present, the control proceeds to step S10, where the activation control unit initializes the shared memory of the remote server to copy the own boot program. For example, in the case of the server 10, after initializing a boot program storage area of the shared memory 26 in the server 12, the activation control unit remotely copies a boot program loaded in, for example, the RAM of the processor 14-1 that has first acquired a processing priority right to perform the boot processing in the shared memory 26.

When no remote server is found at step S9, the control skips step S10. After initializing a time stamp of the own region of the processor table 46, the activation control unit resets the status to disable at step S11.

Though the above embodiment shows the example where two servers having a plurality of processors are provided at two places in a distribution manner, as shown in FIG. 1, a system configuration including the server 10 can be adopted, or the present invention can be applied to even a case where two or more servers such as three servers or four servers are provided at different places as it is.

In the above embodiment, though the processor table 46 on which the time stamp and the own status of a processor acquired from the real time notifying unit by the processor are registered is provided in the shared memory, a position where the processor table should be provided is not limited to the shared memory, and a proper shared storage area such as a register or a table can be utilized as the processor table.

Though the above embodiment shows the example where the time fetch write circuit 68 serving as a hardware functioning as the real time acquiring unit is provided in the processor, a software processing performed by a program executing a time fetch and write instruction of a real time can be adopted, of course.

The present invention includes proper modification that does not damage an object and a merit thereof, and it is not limited by the numerical values shown in the embodiment.

1. A multi-processor apparatus comprising:
a plurality of processors connected via a bus;
a shared storage area that is connected to the bus and stores a boot program used in each processor;
a real time notifying unit that notifies real time information to a read request;
a real time acquiring unit that is provided in each processor and operates just after activation based upon power-on to acquire real time information from the real time notifying control unit and registers the same in a processor table on the shared storage area; and
an activation control unit that is provided in each processor, and that, after registering own real time information of the processor, refers to real time information of another processor registered in the processor table, acquires a priority processing right to read the boot program and cause the processor to perform boot processing, when the own real time is the earliest, and deletes the own real time information from the processor table when the boot processing has been completed.

2. The multi-processor apparatus according to claim 1, wherein
the real time notifying unit produces real time information based upon world standard time information (global time information) received externally.

3. The multi-processor apparatus according to claim 1, wherein
the real time notifying unit produces a time stamp as the real time information,
the real time acquiring unit registers the acquired time stamp in the processor table and registers enable as a status of the own processor, and
the activation control unit acquires a status of a time stamp of another processor from the processor table, determines that the own time stamp is earlier than the time stamp of the another processor without comparing both the time stamps when a status of the another processor is disable, and compares both the time stamps to determine whether or not the own time stamp is earlier than the time stamp of the another processor.

4. The multi-processor apparatus according to claim 1, wherein
the real time acquiring unit is a hardware circuit that continuously performs fetch operation for reading real time information from the real time notifying unit to the bus and write operation for writing time information in the processor table subsequent thereto.

5. The multi-processor apparatus according to claim 4, wherein
the real time notifying unit includes a counter that counts clocks with a cycle equal to or less than a continuous performance time of the fetch operation and the write operation performed by the real time acquiring unit to produce a time stamp.

6. The multi-processor apparatus according to claim 5, wherein
the continuous performance time of the fetch operation and the write operation performed by the real time acquiring unit is the shortest read access time of the bus.

7. The multi-processor apparatus according to claim 1, wherein
the time notifying unit produces a time window with a fixed time width when current time reaches a preset activation time, and the real time acquiring unit and the activation control unit operate only in a time band of the time window to cause a specific processor to acquire a priority processing right and sequentially activate processors.

8. The multi-processor apparatus according to claim 7 wherein
the time notifying unit has a counter that counts clocks with a cycle equal to or less than the shortest read access time of the bus to produce a time stamp and resets the counter at a start time of the time window to start counting of effective time stamps.

9. The multi-processor apparatus according to claim 1, wherein
the plurality of processors, the shared storage area, the time notifying unit, and the activation control unit are provided in each of at least two computer apparatuses provided at different places, and
each computer apparatus produces a time window with a fixed time width, each time when current time reaches a different activation time preset according to remote operation, and each computer apparatus is activated in the activation time order by actuating the real time acquiring unit and the activation control unit of each computer apparatus in the time band of the time window and causing a specific processor to acquire a priority processing right and activate processors sequentially.

10. The multi-processor apparatus according to claim 9, wherein
the activation control unit of a processor that has first acquired the priority processing right in the computer apparatus set with an early activation time initializes the shared storage area in the computer apparatus set with a late activation time to remotely copy the boot program used in an own processor thereof when the boot processing has been terminated.

11. A control method for a multi-processor that uses a boot program stored in a shared storage area connected via a bus to activate a plurality of processors sequentially, comprising
a real-time notifying step of notifying real time information to each processor;
a real-time acquiring step of operating just after activation due to power-on to register real-time information acquired from a real-time notifying unit by each processor on a processor table on the shared storage area; and
an activation control step of referring to real-time information of another processor registered in the processor table after one processor registers own real time information thereof and acquiring a priority processing right to read a boot program and cause the one processor to perform boot processing when the own real-time is earliest, and deleting the own real time information from the processor table when the boot processing has been terminated.

12. The control method for a multi-processor according to claim 11, wherein
the real time notifying step produces real time information based upon world standard time information (global time information) received externally.

13. The control method for a multi-processor according to claim 11, wherein
the real time acquiring step registers the time stamp acquired from the time notifying unit as the real time information in the processor table and registers enable as a status of the own processor, and
the activation control step acquires a status of a time stamp and a status of another processor from the processor table, determines that the own time stamp is earlier than the time stamp of the another processor without comparing both the time stamps when a status of the another processor is disable, and compares both the time stamps to determine whether or not the own time stamp is earlier than the time stamp of the another processor when a status of the another processor is enable.

14. The control method for a multi-processor according to claim 11, wherein
the real time acquiring step continuously performs fetch operation for reading real time information from the real time notifying unit to the bus and write operation for writing time information on the bas in the processor table subsequent thereto.

15. The control method for a multi-processor according to claim 14, wherein
the real time notifying step includes a counter that counts clocks with a cycle equal to or less than a continuous performance time of the fetch operation and the write operation performed by the real time acquiring unit to produce a time stamp.

16. The control method for a multi-processor according to claim 15, wherein
the continuous performance time of the fetch operation and the write operation performed by the real time acquiring step is the shortest read access time of the bus.

17. The control method for a multi-processor according to claim 11, wherein
the time notifying step produces a time window with a fixed time width when current time reaches a preset activation time, and the real time acquiring step and the activation control step operate in a time band of the time window to cause a specific processor to acquire a priority processing right and sequentially activate processors.

18. The control method for a multi-processor according to claim 17, wherein
the time notifying step has a counter that counts clocks with a cycle equal to or less than the shortest read access time of the bus to produce a time stamp and resets the counter at a start time of the time window to start counting of effective time stamps.

19. The control method for a multi-processor according to claim 11, wherein
the plurality of processors, the shared storage area, the time notifying unit, and the activation control unit are provided in each of at least two computer apparatus provided at different places, and
the respective computer apparatuses produce time windows with a fixed time width, respectively, each time when current time reaches different activation time points preset according to remote operation, and the respective computer apparatuses are sequentially activated by performing the real time acquiring steps and the activation control steps of the respective computer apparatuses in the time bands of the time windows and causing a specific processor to acquire a priority processing right and activates processors sequentially.

20. The control method for a multi-processor according to claim 19, wherein
the activation control unit of a processor that has first acquired the priority processing right in the computer apparatus set with an early activation time initializes the shared storage area in the computer apparatus set with a late activation time to remotely copy the boot program used in an own processor thereof when the boot processing has been terminated.
